(19) United States
(12) Patent Application Publication
(10) Pub. No.: US 2006/0059360 A1
(43) Pub. Date: Mar. 16, 2006

(54) Authenticating controller

(76) Inventor: Jerry B. Ortkiese, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/883,517

(22) Filed: Jul. 1, 2004

(51) Int. Cl. H04L 9/00; H04K 1/00

(52) U.S. Cl. 713/183

(57) ABSTRACT

An apparatus including an authenticating controller that controls maximum duration of continuous unattended apparatus operation and modifies the maximum duration after authenticating a command to modify the maximum duration. The apparatus may be an oven, range, or stove, or other household appliance that is a potential source of danger if left operating for extended periods of time.

### BACKGROUND

Many types of apparatus such as household appliances, in particular ovens, ranges, and stoves, are a source of danger if left unattended. In particular, if one begins to cook something on a stove, then leaves the area to perform another task, and subsequently forgets that something is cooking, a fire may result. As another example, if children play with the knobs of a stove and accidentally turn on a burner and leave it on, a fire may result. As such, it is contemplated herein that there is a previously unrecognized need to protect against dangers caused by leaving an operating appliance or other apparatus unattended, and that there is also a previously unrecognized need to protect against unauthorized operation of appliances or other apparatus. This disclosure is directed to apparatus and methods addressing these needs.

### SUMMARY OF THE INVENTION

An embodiment of the invention includes an apparatus including an authenticating controller that controls the maximum duration of continuous unattended apparatus operation and modifies the maximum duration after authenticating a command to modify the maximum duration. In some embodiments, the apparatus is an oven, range, or stove, or other household appliance that is a potential source of danger if left operating for extended periods of time.

### BRIEF DESCRIPTION OF THE DRAWINGS

The exact nature of the invention, as well as the objects and advantages thereof, will become readily apparent from consideration of the following specification in conjunction with the accompanying drawings in which like reference numerals designate like parts throughout the figures thereof and wherein:

FIG. 1 is a simplified block diagram of an apparatus including an oven and an authenticating controller assembly for controlling the operations of the oven.

FIG. 2 is a simplified block diagram of an apparatus including an oven and an authenticating controller assembly at a remote location relative to the oven.

FIG. 3 illustrates a method of modifying an apparatus to utilize an authenticating controller.

FIG. 4 illustrates a method of using an apparatus including an authenticating controller.

FIG. 5 illustrates how an authenticating controller of an apparatus might respond to various events.

### DETAILED DESCRIPTION OF THE PREFERRED EMBODIMENTS

Reference will now be made to the various embodiments of the invention, examples of which are illustrated in the accompanying drawings. While the invention will be described in conjunction with the preferred embodiments, it will be understood that these embodiments are not intended to limit the invention. That is, the invention is intended to cover alternatives, modifications and equivalents, which may be included within the spirit and scope of the invention as defined by the appended claims. In the following detailed description, numerous specific details are set forth in order to provide a thorough understanding of the invention. However, it will be understood by one skilled in the art that the invention may be practiced without these specific details. In other instances, well known methods, procedures, components, and circuits have not been described in detail so as not to unnecessarily obscure aspects of the invention.

An authenticating controller prevents extended unattended operation of household appliances and other apparatus without requiring that a timer be set by a user whenever operation is begun. Such an authenticating controller is beneficially used with stoves, ovens, ranges, and any other household appliances or other apparatus that are a potential source of danger, damage, or cost if left operating for extended periods of time. For simplicity, the examples provided herein are directed primarily to ovens, but are equally applicable to other apparatus such as stoves and ranges.

An authenticating controller as described herein differs from existing oven timers and similar devices in at least two respects. First, the authenticating controller controls the duration of operation without setting the duration each time the oven or other apparatus is turned on. In so doing, the authenticating controller limits the maximum amount of time the oven can operate without operator input rather than the amount of time it is to operate for the current task. Second, the ability to set the duration is limited to authorized individuals, generally those who know a password that is used to modify the duration. The password permits the maximum amount of time to be set by one person, and not be overridden by another person. As an example, if a person is known to be forgetful, someone caring (the “caretaker”) for that forgetful person (or any other person who might operate the oven) may set a maximum duration of unattended operation for the oven to prevent the oven from inadvertently being left on for extended periods of time. If the ability to change the maximum duration is dependent on the use of a password unknown to the forgetful person, the forgetful person is unable to change or override the set maximum duration even if he/she finds it inconvenient to periodically visit the stove during its operation. If the forgetful person subsequently leaves the oven running, it automatically shuts off when it fails to receive timely input from the forgetful person.

In some instances, it is undesirable for the oven to be operated without the knowledge of a caretaker. In such instances, the oven may have an authenticating controller that allows entry of a password before permitting use of the oven. As an example, if a caretaker is responsible for a number of children who have access to the oven when the caretaker is not around, the caretaker can set a password (the “set password”) so that the children are unable to start the oven without first entering a sequence that matches the set password (i.e. entering the password).

In light of the foregoing, in some instances, an apparatus is controlled by an operator who has limited or no control over the duration of continuous apparatus operation. In some instances, another operator, hereinafter the “master operator”, is provided with means for controlling the duration of continuous apparatus operation, and in some instances means for controlling the initiation of apparatus operation. Means for controlling the duration of continuous operation and/or controlling the initiation of apparatus operation, is, in some instances, applicable to an apparatus including an electric or gas range, stove, or oven. Also, a solenoid valve or a relay positioned before a gas or electricity input line may be advantageous in controlling operation. Identifying master operator inputs using one or more set passwords may also be advantageous.

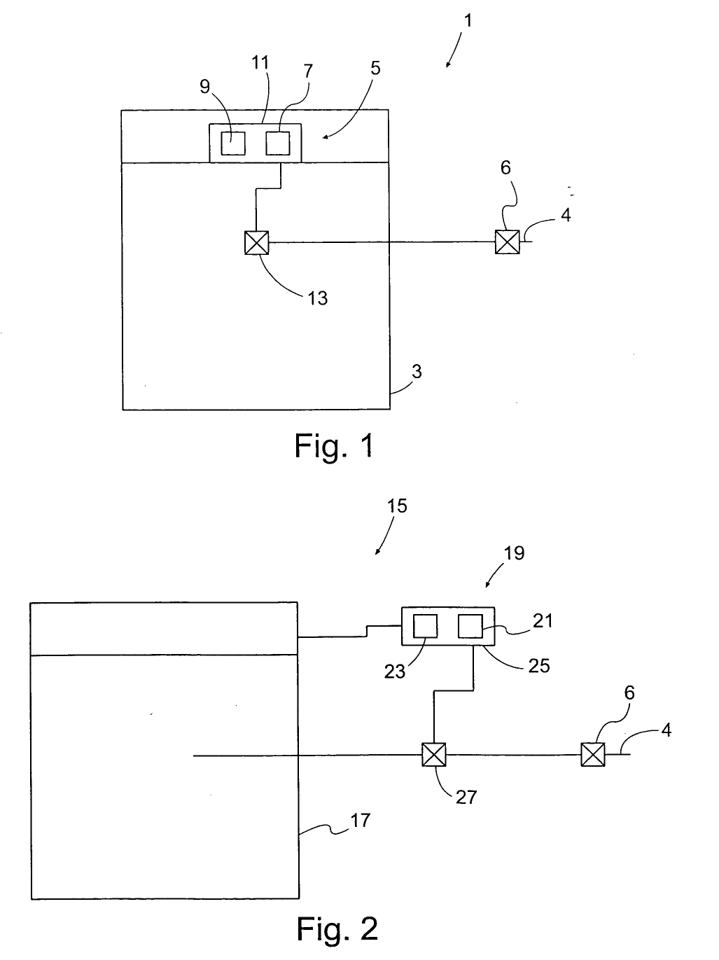

FIG. 1 is a simplified block diagram of an apparatus 1 having an oven 3 and an authenticating controller assembly 5 for controlling the operation of the oven 3. The oven 3 is coupled to a gas source 4 via a primary gas shutoff 6. The controller assembly 5 may include a keypad 7, a digital display 9, and a controller 11 (e.g., an authenticating controller). The controller 11 is coupled to a cutoff device 13 (e.g., a switch or a valve) such that the controller 11 is able to open and close the cutoff device 13. The controller 11 accepts an operator input via the keypad 7 in the form of a password that includes a numeric sequence. If the operator input matches a password already known to the controller 11, the operator input opens the cutoff device 13 for at least a fixed duration. Both the duration and/or the password are provided via the keypad 7 at any time prior to the then current point in time.

In addition to the duration and the password, the operating mode of the controller 11 may also be specified. For example, although many different operating modes may be supported by the controller 11, it is preferred that the controller 11 at least support a first mode where a password is used to specify a duration of continuous unattended operation. In such an instance, gas flow to the oven 3 may not be allowed to extend beyond the specified duration, unless an additional operator input is received prior to the end of the duration. The length of the duration may not be changed unless a request for a change is accompanied by a password authorizing the change. It is also preferred that the controller 11 support a second mode where, in addition to a password being used to change the duration of continuous unattended operation, a password is used to initiate operation for one or more durations. In the first mode or the second mode, the controller 11 provides notice to the operator when the duration is about to expire, possibly via an audible alarm given, for example, two minutes prior to the expiration of the duration, and allows the operator the option of resetting the duration so that it essentially begins anew upon receipt of an appropriate operator input if such input is received after the notice is given but before expiration of the duration. In the second mode of operation, it is preferable that the initial start of a duration of continuous unattended operation involve entry of a password while requests to continue operation for another duration do not. By permitting an operator to restart the duration, the operator is not prevented from utilizing the oven for long periods of time, but can extend the duration of operation by periodically interacting with the oven.

FIG. 2 is a simplified block diagram of an apparatus 15 including an oven 17 and an authenticating controller assembly 19 at a remote location relative to the oven 17. The controller assembly 19 may include a keypad 21, a digital display 23, and a controller 25 (e.g., an authenticating controller). The controller 25 is coupled to a cutoff device 27 such that the controller 25 is able to open and close the cutoff device 27. The apparatus 15 of FIG. 2 differs from that of FIG. 1 primarily in regard to utilizing the remote controller assembly 19 and the cutoff device 27 rather than integral ones. The controller 25 preferably has many of the same characteristics described in regard to the controller 11 of FIG. 1.

Although FIGS. 1 and 2 illustrate embodiments including gas ovens, the subject matter herein is applicable to apparatus utilizing other energy sources such as electricity, as well as any other apparatus that is preferred not to be operated for extended periods of unattended operation. In some instances extended operation might be dangerous or might be likely to result in damage, while in others, it might simply be costly. As such, the subject matter herein is applicable to other types of apparatus such as at least those including stoves, ranges, bathtubs, hair and clothes irons, and air conditioners.

The controllers as described herein may include one or more electrical circuits that control flow to the apparatus of gas, electricity, or whatever other source of energy the apparatus uses. This may be accomplished by a cutoff device which may be a solenoid valve controlling the flow of gas into the oven. In alternative embodiments, a device, other than a solenoid valve, may be used. An example of one such device is an electrical relay that controls the flow of electricity. As used herein “opening the cutoff device” or causing the cutoff “to open” results in electricity, gas, or some other energy or energy source flowing into the apparatus. However, if the cutoff is a relay or similar device, “opening the cutoff device” may in some instances be equivalent to “closing the relay”. Similarly, “closing the cutoff device” results in an interruption in the flow to the apparatus. If the cutoff device is a relay, “closing the cutoff device” may in some instances be equivalent to “opening the relay”.

In support of the first mode of operation, the controller may be able to sense or receive an input indicating that an operator has requested that the apparatus operations begin so that the controller can keep track of when continuous unattended operation is to be halted by closing the cutoff device. As an example, an operator may request to start operation, possibly via a button or other input on the apparatus being started, and may cause a signal to be sent to the controller to cause the controller to open the cutoff device. An alternative is to have the controller assembly include a start button or other device that interacts with the apparatus so that a request to start input via the controller assembly is communicated to the apparatus being started. If the controller receives a signal, detects a change in state of the apparatus, or otherwise detects operator interaction indicating that operation is to begin or a duration is to be reset, the controller can be said to have received a start command.

It is contemplated that in some instances the controller and whatever mechanisms it may use to control energy flow into the apparatus may be a part of the apparatus as shown in FIG. 1, and/or may be separate from the apparatus as shown in FIG. 2. As an example, the keypad, the digital display, the controller and the cutoff device could be positioned external to the oven. In such an instances, energy flow to the apparatus can be controlled via the controller and the cutoff device without having to make any modifications to the oven.

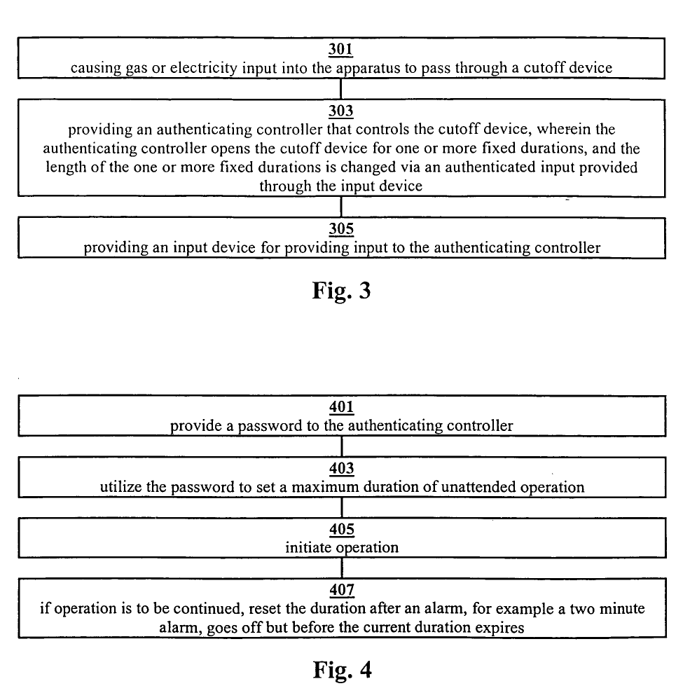

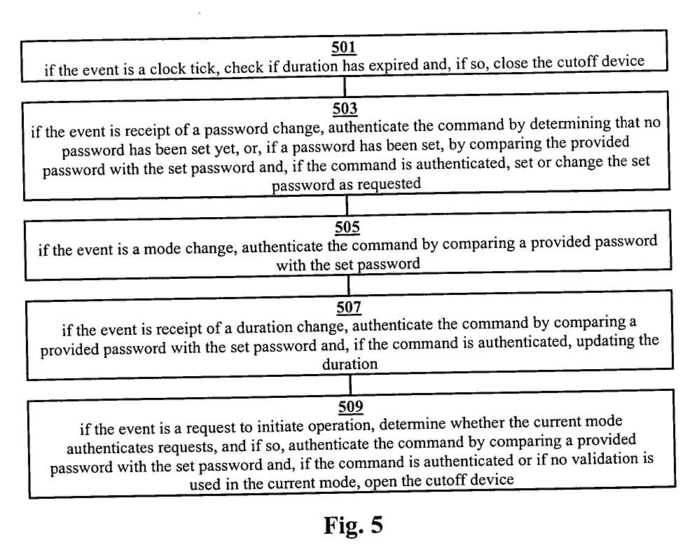

As illustrated by FIG. 3, a method of modifying an apparatus may include: step 301, causing gas or electricity input into the apparatus to pass through a cutoff device; step 303, providing an authenticating controller that controls the cutoff device, wherein the authenticating controller opens the cutoff device for one or more fixed durations, and the length of the one or more fixed durations is changed via an authenticated input provided through the input device; and step 305, providing an input device for providing input to the authenticating controller.

The apparatus, such as those shown in FIGS. 1 and 2, may be operated utilizing the following steps: step 401, provide a password to the authenticating controller; step 403, utilize the password to set a maximum duration of unattended operation; step 405, initiate operation; and step 407, if operation is to be continued, reset the duration after an alarm, for example a two minute alarm, goes off but before the current duration expires.

The authenticating controller may respond to various events using one or more of the following steps: step 501, if the event is a clock tick, check if the duration has expired and, if so, close the cutoff device; step 503, if the event is receipt of a password change, authenticate the command by determining that no password has been set yet, or, if a password has been set, by comparing the provided password with the set password and, if the command is authenticated, set or change the set password as requested; step 505, if the event is a mode change, authenticate the command by comparing a provided password with the set password; step 507, if the event is receipt of a duration change, authenticate the command by comparing a provided password with the set password and, if the command is authenticated, updating the duration; and step 509, if the event is a request to initiate operation, determine whether the current mode authenticates requests and if so, authenticate the command by comparing a provided password with the set password, and, if the command is authenticated or if no validation is used in the current mode, open the cutoff device.

Although the use of an authenticating controller is especially advantageous on apparatus that do not utilize any other timers to control operation, it may also advantageously be used on apparatus that do utilize other timers. In many instances the ability to set a maximum unattended duration may supplement the ability to use an oven timer or other device used to set another duration that is specific to the current task being performed. As an example, an oven including an authenticating controller as described herein might also have an authenticating controller that utilizes a user settable timer to determine when to stop and start operation of the oven. In instances where the task specific timer is set, and the duration set is less than the maximum unattended duration, the authenticating controller does not have to stop operation of the oven. In instances where the timer is not set and the oven is allowed to operate until turned off, the authenticating controller stops operation if the operating time of the oven exceeds the maximum unattended duration.

The examples described herein discuss the use of a keypad and a numeric password. However, any other reasonable method of authentication may be used. Such methods include, but are not necessarily limited to, the use of non-numeric passwords, key cards, biometric data, and/or voice recognition.

The examples described herein are directed primarily to cutting off the source of gas or electricity into the apparatus. However, other embodiments may utilize different methods of preventing unattended operation from exceeding a set duration.

The embodiments described herein include multiple novel features with each described embodiment including either a single such feature or a combination of such features. Other contemplated embodiments include all combinations of one or more such novel features not explicitly described herein as such combinations are readily discernable from the embodiments described. In light of the various contemplated embodiments, the invention can be described in a number of ways with the following paragraphs providing examples of some embodiments.

Some embodiments include an apparatus having an authenticating controller that controls maximum duration of continuous apparatus operation and modifies the maximum duration after authenticating a command to modify the maximum duration.

Some embodiments include an apparatus having: an input line; a valve positioned such that gas passes through the valve before entering the input line; and an authenticating controller controlling the valve, the authenticating controller storing one or more authenticating passwords, to open the valve for one or more fixed durations after receiving a password that matches one or more of the one or more authenticating passwords, to provide notice when a current duration is about to expire, to close the valve at the end of the current duration unless a start command is received between when notice is provided and the end of the current duration, to end the current duration while leaving the valve open for another duration if a start command is received between when notice is provided and the end of the current duration. Some such embodiments may also include or satisfy one or more of the following: (a) the authenticating controller will not act on any start command that is not preceded or accompanied by a password that matches one or more of the authenticating passwords; (b) the apparatus is a gas oven; and (c) the apparatus includes a gas oven, the authenticating controller, and the valve; and the authenticating controller and/or the valve are physically separate from the oven.

Some embodiments include a gas oven having an input line and an authenticating controller controlling gas flow through the input line by opening and closing a cutoff device such as a solenoid valve or relay such that the cutoff device is opened for one or more fixed durations wherein the length of the duration can be changed via an authenticated input. Some such embodiments may further include or satisfy one or more of the following: (a) each fixed duration begins upon controller receipt of a start command; (b) a particular duration may overlap a prior duration if a start command is received prior to the end of the prior duration; (c) the authenticating controller provides notice when a particular duration is about to end; (d) unless a start command is received after the notice is provided and prior to the end of the duration, the authenticating controller closes the cutoff device at the end of the duration; (e) each start command is authenticated prior to the authenticating controller accepting it as a command to begin a duration; (f) authentication of a duration change and/or a start command includes comparing an operator provided password with a set password; and (g) the oven includes a body and at least first and second sets of input devices wherein the first set of input devices is positioned on or within the body and the second set of input devices is positioned with the authenticating controller away from the body, and the second set of input devices is electrically coupled to the authenticating controller and used to authenticate duration changes and/or start commands.

Some embodiments include a method of limiting use of a gas oven including: causing gas input into the oven to pass through a cutoff device; providing an authenticating controller that controls the cutoff device; providing an input device for providing input to the authenticating controller; wherein the authenticating controller opens the cutoff device for one or more fixed durations; the length of the one or more fixed durations can be changed via an authenticated input provided through the input device. Some such embodiments may further include or satisfy one or more of the following: (a) each fixed duration begins upon controller receipt of a start command from the input device; (b) a particular duration may overlap a prior duration if a start command is received prior to the end of the prior duration; (c) the authenticating controller provides notice when a particular duration is about to end; (d) unless a start command is received after the notice is provided and prior to the end of the duration, the authenticating controller closes the cutoff device at the end of the duration; (e) each start command is authenticated prior to the authenticating controller accepting it as a command to begin a duration; (f) authentication of a duration change and/or a start command includes comparing an operator provided password with a set password; and (g) the cutoff device and authenticating controller are added to the oven after initial use of the oven.

What is claimed is:

1. An apparatus comprising an authenticating controller that controls a maximum duration of continuous unattended apparatus operation and modifies the maximum duration after authenticating a command to modify the maximum duration.

2. The apparatus of claim 1 wherein the authenticating controller controls energy or fuel flow into the apparatus by opening and closing a cutoff device such that the cutoff device is opened for one or more fixed durations wherein the one or more fixed durations are each less than or equal to the maximum duration.

3. The apparatus of claim 2 wherein each fixed duration begins upon receipt of a start command from the authenticating controller.

4. The apparatus of claim 3 wherein a particular duration may overlap a prior duration if a start command is received prior to the end of the prior duration.

5. The apparatus of claim 4 wherein the authenticating controller provides a notice when the prior duration is about to end.

6. The apparatus of claim 5 wherein, unless the start command is received after the notice is provided and prior to the end of the prior duration, the authenticating controller closes the cutoff device at the end of the prior duration.

7. The apparatus of claim 6 wherein each start command is authenticated prior to the authenticating controller accepting it as a command to begin a duration.

8. The apparatus of claim 7 wherein authentication of a duration change or a start command comprises comparing an operator provided input sequence with a previously set password.

9. The apparatus of claim 8 further comprising a body and at least first and second sets of input devices wherein the first set of input devices is positioned on or within the body and the second set of input devices is positioned with the authenticating controller away from the body, and the second set of input devices is electrically coupled to the authenticating controller and used to authenticate duration changes or start commands.

10. An apparatus comprising:
a cutoff device positioned such that gas or electricity passes through the cutoff device before being used in operating the apparatus, the cutoff device being open if gas or electricity can pass through the cutoff device and closed if gas or electricity is inhibited from passing through the cutoff device; and
an authenticating controller controlling the cutoff device, the authenticating controller
storing one or more authenticating passwords,
opening the cutoff device for one or more fixed durations after receiving a password that matches one or more of the one or more authenticating passwords,
providing notice when a current duration is about to expire,
closing the cutoff device at the end of the current duration unless a start command is received between when the notice is provided and the end of the current duration, and
ending the current duration while leaving the cutoff device open for another duration if a start command is received between when the notice is provided and the end of the current duration.

11. The apparatus of claim 10 wherein the authenticating controller will not act on any start command that is not preceded or accompanied by a password that matches one or more of the authenticating passwords.

12. The apparatus of claim 11 wherein:
the apparatus comprises a gas or electric oven, range or stove, the authenticating controller, and the cutoff device; and
the authenticating controller and the cutoff device are physically separate from the oven, range, or stove.

13. A method of limiting use of an apparatus comprising:
causing gas or electricity input into the apparatus to pass through a cutoff device;
providing an authenticating controller that controls the cutoff device;
providing an input device for providing input to the authenticating controller; wherein the authenticating controller opens the cutoff device for one or more fixed durations; and
the length of the one or more fixed durations is changed via an authenticated input provided through the input device.

14. The method of claim 13 wherein each fixed duration begins upon receipt from the authenticating controller of a start command indicating operator interaction with the input device.

15. The method of claim 14 wherein a particular duration may overlap a prior duration if a start command is received prior to the end of the prior duration.

16. The method of claim 15 wherein the authenticating controller provides notice when the prior duration is about to end.

17. The method of claim 16 wherein, unless a start command is received after the notice is provided and prior to the end of the prior duration, the authenticating controller closes the cutoff device at the end of the prior duration.

18. The method of claim 17 wherein each start command is authenticated prior to the authenticating controller accepting it as a command to begin the particular duration.

19. The method of claim 18 wherein authentication of a duration change or a start command comprises comparing an operator provided input sequence with a set password.

20. The method of claim 19 wherein the cutoff device and authenticating controller are added to the apparatus after initial use of the apparatus.
